(19) United States
(12) Patent Application Publication
(10) Pub. No.: US 2010/0063723 A1
(43) Pub. Date: Mar. 11, 2010

(54) METHOD FOR PROVIDING LOCATION BASED SERVICE EVENT INFORMATION, AND A LOCATION BASED SERVICE PLATFORM IMPLEMENTING THE SAME, AND METHOD FOR DISPLAYING A LOCATION BASED SERVICE EVENT MESSAGE, AND A PORTABLE ELECTRONIC DEVICE IMPLEMENTING THE SAME

(75) Inventor: Yung-Chao LEE, Taipei City (TW)

Correspondence Address: LADAS & PARRY, 5670 WILSHIRE BOULEVARD, SUITE 2100, LOS ANGELES, CA, 90036-5679, US

(73) Assignee: MITAC INTERNATIONAL CORP., Hsinchu (TW)

(21) Appl. No.: 12/552,897

(22) Filed: Sep. 2, 2009

(30) Foreign Application Priority Data
Sep. 8, 2008 (TW) 097134383

(51) Int. Cl. G01C 21/00; H04W 24/00

(52) U.S. Cl. 701/201; 455/456.3

(57) ABSTRACT

A method for displaying a location based service (LBS) event message to be implemented by a target portable electronic device includes the steps of: (a) upon receipt of the LBS event message, retrieving an event title from the LBS event message; and (b) displaying the event title in a ticker display manner on a display screen of the target portable electronic device.

### CROSS-REFERENCE TO RELATED APPLICATION

This application claims priority of Taiwanese Application No. 097134383, filed on Sep. 8, 2008.

### BACKGROUND OF THE INVENTION

1. Field of the Invention

The invention relates to a method for providing and displaying location based service (LBS) event information, more particularly to a method for providing LBS event information to a target portable electronic device to be implemented by a LBS platform, and a method for displaying a LBS event message in a ticker display manner to be implemented by the target portable electronic device.

2. Description of the Related Art

The growing popularity of global positioning system (GPS) technology and wireless communication technology has facilitated the development of location based services (LBS) for portable electronic devices.

Upon obtaining the current location of a portable electronic device with the assistance of a positioning module (e.g., a GPS module) of the portable electronic device and/or a wireless communication system network, a service platform provides the portable electronic device with information relevant to its neighboring area, such as information regarding real-time road conditions, location inquiries, navigation services, or LBS event messages regarding exhibitions, promotion sales, performances, local celebrations, etc., in the neighborhood.

A conventional service platform transmits the entire content of an LBS event message, which may include title, location, introduction, and time of an upcoming event, to the portable electronic devices for display, and the portable electronic devices are forced to receive this kind of LBS event messages. Since LBS event messages are normally sent via short messaging service, a user has to select individual messages in order to read the content thereof, which is often of no interest to the user. Moreover, due to the over abundance of the LBS event messages, the messages may not be read in time (i.e., before the time of the event expires), or the user may lose patience and decide to delete them without reading. As a result, information in LBS event messages that may be of interest to the user may be disregarded.

### SUMMARY OF THE INVENTION

Therefore, the main object of the present invention is to provide a method for displaying a location based service (LBS) event message in a portable electronic device so as to make the LBS event message available for a user in real-time, and to a portable electronic device that implements the method.

Another object of the present invention is to provide a more efficient way of providing location based service (LBS) event information to a target portable electronic device, and a LBS platform implementing the same.

Yet another object of the present invention is to provide a method for providing LBS event messages in a more customized manner, and to a LBS platform that implements the method.

According to one aspect of the present invention, there is provided a method for displaying a location based service (LBS) event message to be implemented by a target portable electronic device. The method includes the steps of:

(a) upon receipt of the LBS event message, retrieving an event title from the LBS event message; and

(b) displaying the event title in a ticker display manner on a display screen of the target portable electronic device.

In one implementation, the aforementioned LBS event message is a full LBS event message that contains the event title and event information. In step (b), the event title is displayed in a manner that the event title is made available for selection by a user of the target portable electronic device. The method further includes the step of: (c) upon detection of selection of the event title, displaying the event information on the display screen of the target portable electronic device.

In another implementation, the aforementioned LBS event message is a brief LBS event message that contains the event title. In step (b), the event title is displayed in a manner that the event title is made available for selection by a user of the target portable electronic device. The method further includes the steps of: (c) upon detection of selection of the event title, transmitting a full content request to a location based service (LBS) platform for requesting event information corresponding to the event title that has been selected; and (d) upon receipt of the event information, displaying the event information on the display screen of the target portable electronic device. Preferably, the event information includes at least one of location, time, and introduction of an event corresponding to the event title of the brief LBS event message.

This way, the user has the opportunity to decide whether he/she is interested in reading the LBS event information by inspecting the event title.

Preferably, the target portable electronic device has at least one event type preference stored therein, and step (a) is performed upon determining that an event type of the LBS event message has a match with said at least one event type preference stored in the target portable electronic device.

According to another aspect of the present invention, there is provided a method for providing location based service (LBS) event information to a target portable electronic device. The method is to be implemented by a location based service (LBS) platform and includes the steps of:

(a) configuring the LBS platform to register therein a plurality of full LBS event messages, each of which contains an event identification code, an event title, and event information;

(b) configuring the LBS platform to form a brief LBS event message corresponding to one of the full LBS event messages by extracting the event identification code and the event title therefrom; and

(c) configuring the LBS platform to transmit the brief LBS event message to the target portable electronic device.

Preferably, the method further includes the step of: (d) configuring the LBS platform to transmit, upon receipt of a full content request, the event information corresponding to the event title to the target portable electronic device. The LBS platform is configured to locate the event information corresponding to the full content request using the event identification code for subsequent transmission to the target portable electronic device.

More preferably, the method further includes the following step prior to step (a): (e) configuring the LBS platform to select, upon being informed of a current location of the target portable electronic device, at least one brief LBS event message that corresponds to the current location of the target portable electronic device for transmission to the target portable electronic device in step (a).

More preferably, the method further includes the following step prior to step (e): (f) upon receipt of at least one event type preference from the target portable electronic device, configuring the LBS platform to store said at least one event type preference. In step (e), the LBS platform selects at least one brief LBS event message that corresponds to the current location of the target portable electronic device and that has a match with said at least one event type preference for transmission to the target portable electronic device in step (a).

In sum, the present invention permits provision of the LBS event information in stages. In the first stage, a brief LBS event message is sent according to a user's event type preferences and is displayed in a ticker display manner on a target portable electronic device. In the second stage, a full LBS event message is sent at the user's request. As a result, the target portable electronic device only receives those brief LBS event messages that match the user's preferences, and the user only has to read those detailed event information that he/she is interested in after being notified of the presence of the events in a ticker display manner, thereby achieving a more customized and efficient service.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram, illustrating transmission between portable electronic devices and location based service (LBS) platforms according to the preferred embodiment of the present invention;

FIG. 2 is a block diagram of the LBS platform according to the preferred embodiment;

FIG. 3 is a block diagram of a target portable electronic device according to the preferred embodiment;

FIG. 4 is a flowchart of a method for providing LBS event information to a target portable electronic device according to the preferred embodiment; and

FIG. 5 is a flowchart of a method for displaying LBS event messages in a target portable electronic device according to the preferred embodiment.

### DETAILED DESCRIPTION OF THE PREFERRED EMBODIMENT

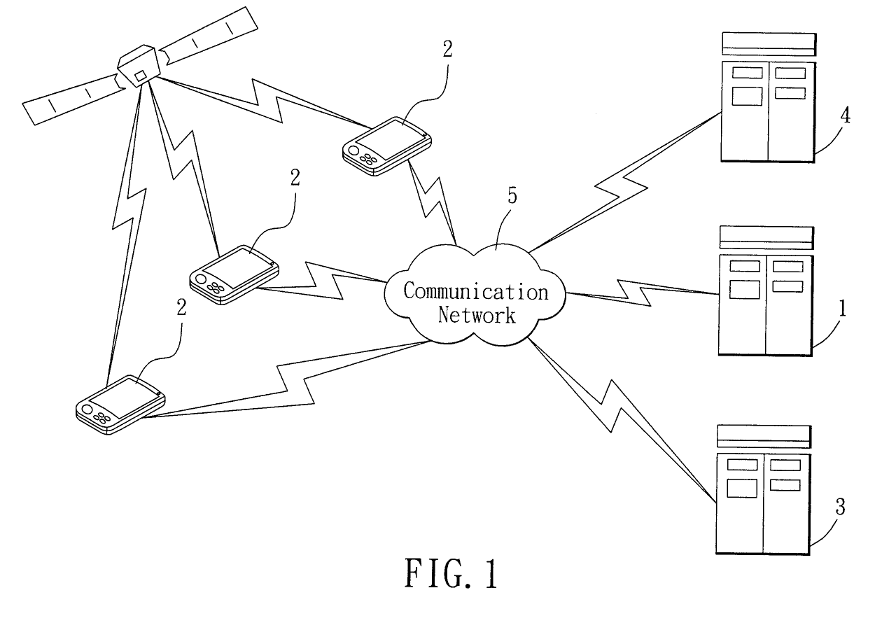

Referring to FIG. 1, the preferred embodiment of a location based service (LBS) event message transmission framework according to the present invention includes a location based service (LBS) platform 1 in accordance with the present invention for providing location based service (LBS) event information, several other LBS platforms 3, 4 not in accordance with the present invention, and a plurality of portable electronic devices 2. In the following description, a particular one of the portable electronic devices 2 that communicates with the LBS platform 1 will be referred to as a target portable electronic device 2, and the phrases “portable electronic device” and “target portable electronic device” may be used interchangingly.

The LBS platform 1 is informed of a current location of the target portable electronic device 2 via a communication network 5, and provides LBS event information to the target portable electronic device 2 via the communication network 5. The communication network 5 may be a general packet radio service (GPRS) network, a global system for mobile communication (GSM) network, the Internet, etc.

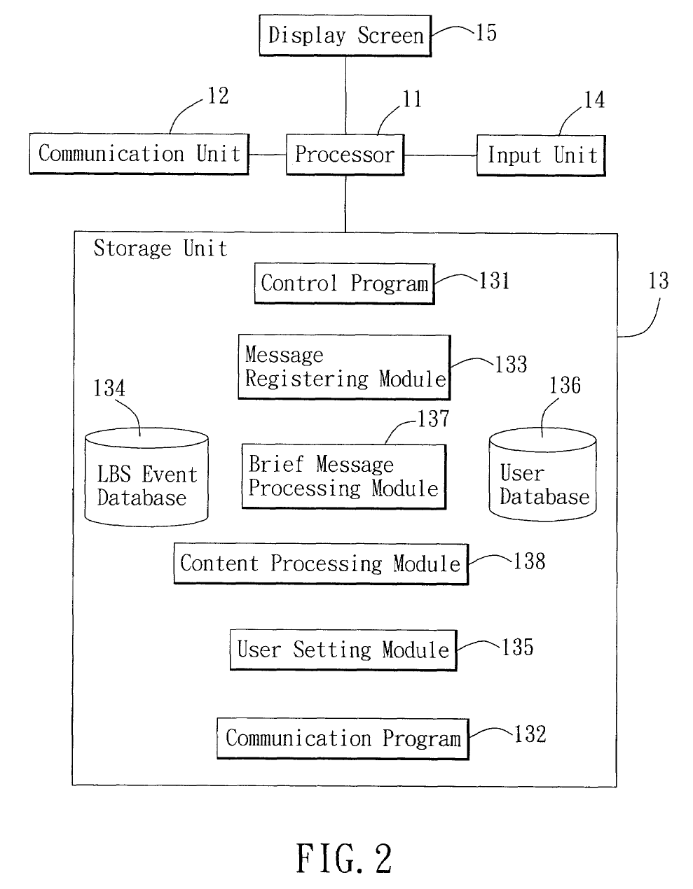

With reference to FIG. 1 and FIG. 2, the LBS platform 1 of this embodiment is a server, and includes a processor 11, a communication unit 12, and a storage unit 13. The storage unit 13 may be a non-volatile memory (e.g., a flash memory), a hard disk or any other memory devices, and contains programs and data necessary for providing LBS event services to the target portable electronic device 2 according to the present invention. The processor 11 is coupled electrically to the communication unit 12 and the storage unit 13. The LBS platform 1 may further include other common components that constitute a server, such as an input unit 14 (e.g., a keyboard and/or a mouse), and a display screen 15, etc., and should not be limited to those disclosed herein.

In this embodiment, the storage unit 13 contains a control program 131, a communication program 132, a message registering module 133, a location based service (LBS) event database 134, a user setting module 135, a user database 136, a brief message processing module 137, and a content processing module 138.

The control program 131, when loaded into the processor 11, acts as an operating system (e.g., UNIX) for providing basic functions of the LBS platform 1.

The communication program 132, when loaded into the processor 11, acts as a driver for the communication unit 12, and enables transmission of data via the communication unit 12.

The message registering module 133, when loaded into the processor 11, configures the processor 11 to register a plurality of full LBS event messages into the LBS event database 134. Regardless of whether the full LBS event messages are provided by the provider of the LBS platform 1 or providers of other LBS platforms 3, 4, the processor 11 is configured to register the full LBS event messages into the LBS event database 134 upon receiving them either from the input unit 14 or via the communication unit 12. Each of the full LBS event messages contains an event title, an event identification code, and event information. In this embodiment, the event information includes location, time, and introduction of an event corresponding to the event title. Each of the full LBS event messages further includes an event type, such as art, sport, local celebration, exhibition, sale, food, etc. The message registering module 133 further configures the processor 11 to categorize the full LBS event messages according to the different event types. In addition, the message registering module 133 further configures the processor 11 to remove, from the LBS event database 134, those full LBS event messages that have expired, i.e., the time of the event corresponding to the event title thereof has expired. Moreover, the message registering module 133 may further configure the processor 11 to search or request for full LBS event messages from other LBS platforms 3, 4.

In order to provide the user with suitable LBS event message services according to the user's needs, the user setting module 135, when loaded into the processor 11, configures the processor 11 to record and manage user information of the portable electronic devices 2 in the user database 136. The user information contains a plurality of event type preference lists respectively corresponding to a plurality of user identifications (i.e., portable electronic device identifications). Upon receipt of event type preference(s) from one of the portable electronic devices 2, the processor 11 is configured by the user setting module 135 to update the user database 136 by updating the corresponding event type preference list after locating the same using the user identification.

The brief message processing module 137, when loaded into the processor 11, configures the processor 11 to retrieve, upon determining that a triggering condition is satisfied, the event title of one of the full LBS event messages from the LBS event database 134 so as to generate a brief LBS event message containing the event title, and to control the communication unit 12 to transmit the brief LBS event message to the target portable electronic device 2. Said one of the full LBS event messages corresponds to a current location of the target portable electronic device 2, has a match with event type preference(s) listed in the event type preference list corresponding to the user identification of the target portable electronic device 2 in the user database 136, and the time of the corresponding event has not expired. In this embodiment, the triggering condition is satisfied when it is determined by the processor 11 that the current location of the target portable electronic device 2 is received via the communication unit 12.

The current location may be obtained by the target portable electronic device 2 with the assistance of the communication network 5 (e.g., GPS network), and is transmitted over the communication network 5 to the LBS platform 1 for receipt via the communication unit 12. Since there are currently many ways for determining the current location of the target portable electronic device 2, one of which is disclosed in U.S. Pat. No. 6,311,069, further details of the same are omitted herein for the sake of brevity. In an instance, the LBS platform 1 may cooperate with the provider of the communication network 5, a mobile positioning center (MPC) of which transmits the current location of the target portable electronic device 2, for example, in coordinate system, to the LBS platform 1 upon acquiring the same.

More specifically, the processor 11 is configured by the brief message processing module 137 to, first, identify the target portable electronic device 2 using the user identification, second, locate the event type preference list that corresponds to the target portable electronic device 2 from the user database 136, third, select at least one full LBS event message related to an upcoming event from the LBS event database 134 according to the current location of the target portable electronic device 2, the event type preference list thus located, and a current time, and fourth, extract the event identification code and the event title from the LBS event message thus selected so as to form a corresponding brief LBS event message. It should be noted herein that several full LBS event messages may be selected as long as each of them matches all the above conditions. In that case, several brief LBS event messages would be formed and transmitted to the target portable electronic device 2. As a result, the user of the target portable electronic device 2 is informed, by each brief LBS event message, of the existence of an upcoming event of his/her own preference that is to take place at a nearby location without having to read through many detailed event messages that he/she might not even be interested in. Moreover, the volume of data transmitted by the LBS platform 1 is greatly reduced.

Upon receipt of the brief LBS event message, if the user is interested from the event title and wishes to learn more information about the event, the user may use the target portable electronic device 2 to transmit a full content request to the LBS platform 1, requesting event information corresponding to the event title of the brief LBS event message (more details of which will be disclosed later). Upon receipt of the full content request from the target portable electronic device 2, the content processing module 138, which is loaded into the processor 11, configures the processor 11 to retrieve the event information, including the location, time, and introduction of the event, from the corresponding one of the full LBS event messages, and to transmit the event information thus retrieved to the target portable electronic device 2. In particular, the processor 11 is configured to locate, in the LBS event database 134, the event information corresponding to the full content request using the event identification code.

Consequently, according to the method for providing LBS event information to a target portable electronic device 2 of the present invention, if the full LBS event messages stored in the LBS event database 134 of the LBS platform 1 are related to commercial advertisements, the LBS platform 1 is configured to notify the user of the target portable electronic device 2 only of the event titles of selected events, preferably, of the user's preference, so as not to force promotion upon the user, and if the user is interested in learning more information regarding a particular event, the LBS platform 1 is further configured to provide the same at the user's request.

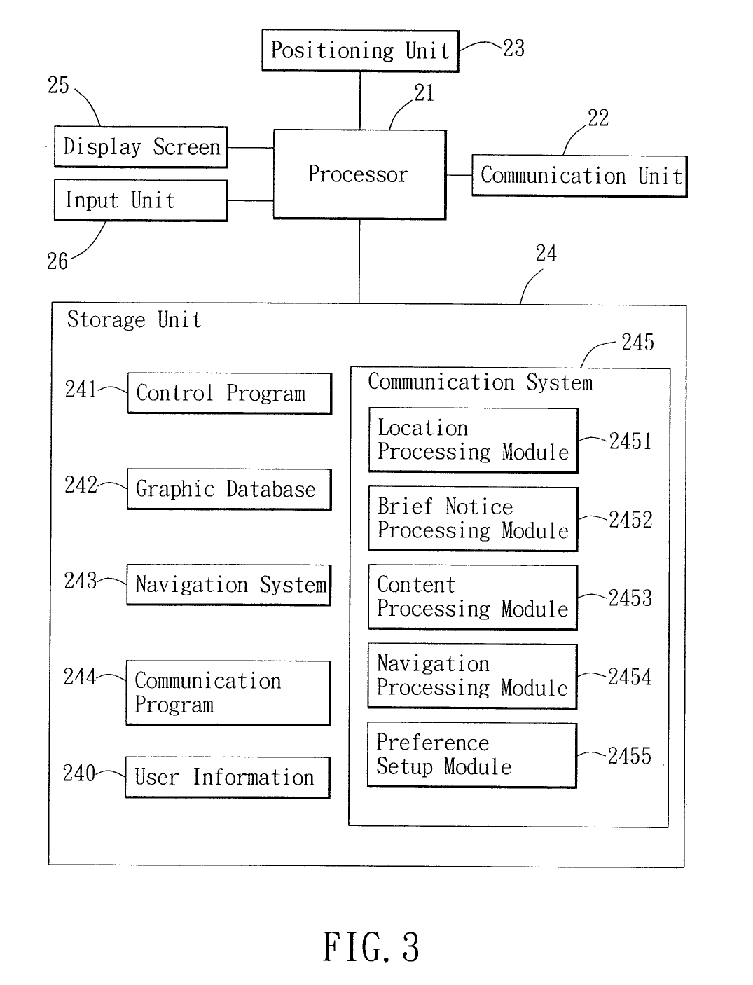

With reference to FIG. 1 and FIG. 3, each of the portable electronic devices 2 may be a cell phone, a portable navigation device, etc. According to the preferred embodiment, each of the portable electronic devices 2 is a navigation device, and includes a processor 21, a communication unit 22, a positioning unit 23, a storage unit 24, a display screen 25, and an input unit 26.

The communication unit 22 is used for receiving the LBS event messages from the LBS platforms 1, 3, 4 via the communication network 5. Assuming that the communication network 5 is a GSM network, the communication unit 22 may communicate using technologies such as GPRS, Short message Service (SMS) Multimedia Messaging Service (MMS), etc.

The processor 21 is coupled electrically to the communication unit 22, the storage unit 24, the display screen 25, and the input unit 26 (e.g., touchpad, keyboard, etc.) for controlling operation of these components. The processor 21 stores the LBS event messages received via the communication unit 22 in the storage unit 24.

The storage unit 24 maybe a non-volatile memory (e.g., a flash memory), or any other memory devices, and contains programs and data necessary for operation according to the present invention. In this embodiment, the storage unit 24 contains a control program 241, a graphic database 242, a navigation system 243, a communication program 244, user information 240, and a communication system 245.

The control program 241, when loaded into the processor 21, acts as an operating system (e.g., WIN CE) for providing basic functions of the portable electronic device 2, and enables the positioning unit 23 to obtain the current location of the portable electronic device 2.

The graphic database 242 stores geographical data for use by the navigation system 243.

The navigation system 243 provides navigation functionalities, such as planning a navigation route with reference to the graphic database 242. In this embodiment, the navigation system 243, when loaded into the processor 21, configures the processor 21 to generate a navigation route based on a start location and a destination location with reference to the geographical data stored in the graphic database 242.

The communication program 244, when loaded into the processor 21, acts as a driver for the communication unit 22, and enables transmission of data via the communication unit 22.

The user information 240 contains the user identification (e.g., a unique portable electronic device identification or a user registration code) and settings of the portable electronic device 2.

The positioning unit 23, which is a Global Positioning System (GPS) receiver in this embodiment, is coupled electrically to the processor 21, and determines the current location of the portable electronic device 2 according to the GPS signals received thereby.

The portable electronic device 2 of the present invention mainly differs from other portable navigation devices in further comprising the communication system 245, which is automatically loaded into the processor 21 when the portable electronic device 2 is turned on in this embodiment. In another implementation, the communication system 245 may be stored in a removable memory device, such as an optical disc, and loaded into the portable electronic device 2 when needed.

The communication system 245 contains a location processing module 2451, a brief notice processing module 2452, a content processing module 2453, a navigation processing module 2454, and a preference setup module 2455.

The location processing module 2451, when loaded into the processor 21, configures the processor 21 to enable transmission of the current location of the portable electronic device 2 to the LBS platforms 1, 3, 4 via the communication unit 22 so as to inform the LBS platforms 1, 3, 4 of the same upon determining that a triggering condition is satisfied. In this embodiment, the triggering condition is satisfied when it is determined by the processor 21 that the current location of the portable electronic device 2 has changed (e.g., beyond a predefined distance), or that a predefined period of time has elapsed (e.g., since the previous transmission of the current location), or when the portable electronic device 2 has just been turned on. In particular, an identification information, e.g., IP address, of each LBS platform 1, 3, 4 is stored in the storage unit 24. When the triggering condition is satisfied, the processor 21 is configured by the location processing module 2451 to transmit the current location of the portable electronic device 2 as determined by the positioning unit 23, along with the user identification contained in the user information 240, to the LBS platforms 1, 3, 4 via the communication unit 22 so as to inform the LBS platforms 1, 3, 4 of the same and await LBS event services therefrom. As mentioned above, upon receiving the LBS event message(s) from the LBS platforms 1, 3, 4 via the communication unit 22, the processor 21 stores the same in the storage unit 24.

In order to notify the user of the portable electronic device 2 of the presence of upcoming nearby events without interrupting current operation of the portable electronic device 2, the portable electronic device 2 is provided with the brief notice processing module 2452, which, when loaded into the processor 21, configures the processor 21 to retrieve the event title(s) of the LBS event message(s) from the storage unit 24, and further configures the processor 21 to enable the display screen 25 to display the event title(s) in a ticker display manner. The processor 21 may be configured to enable the display of the event title(s) repeatedly for several times. Moreover, the processor 21 is further configured by the brief notice processing module 2452 such that the event title is displayed on the display screen 25 in a manner that the event title is made available for selection by the user using the input unit 24.

In the following description, it is assumed that one LBS event message is received for simplicity. In the case where the LBS event message is a brief LBS event message that contains the event title (such as that transmitted from the LBS platform 1 in accordance with the present invention), the content processing module 2453, when loaded into the processor 21, configures the processor 21 to transmit through the communication unit 22, upon detection of selection of the event title, a full content request to the LBS platform 1 for requesting event information corresponding to the event title that has been selected. The content processing module 2453 further configures the processor 21 to enable, upon receipt of the event information from the LBS platform 1 via the communication unit 22, the display screen 25 to display the event information. The full content request contains the event identification code corresponding to the selected event title, and the user identification contained in the user information 240. On the other hand, in the case where the LBS event message is a full LBS event message that contains both the event title and the event information (such as that transmitted from the LBS platforms 3, 4 not in accordance with the present invention), the content processing module 2453, when loaded into the processor 21, configures the processor 21 to retrieve the event information of the LBS event message from the storage unit 24, and to enable the display screen 25 to display the event information upon detection of selection of the event title.

In order to assist the user of the portable electronic device 2 in going to the location of the event as notified in the event information, the navigation processing module 2454, when loaded into the processor 21, configures the processor 21 to enable the display screen 25 to display a navigation option that is available for selection by the user when the event information is being displayed. The navigation processing module 2454 further configures the processor 21 to set, upon detection of selection of the navigation option, the current location of the portable electronic device 2 as the start location, and the event location contained in the event information as the destination location for subsequent generation of the navigation route by the navigation system 243 with reference to the geographical data contained in the graphic database 242.

It should be noted herein that since some LBS platforms provide navigation functionalities, when the portable electronic device 2 is not a navigation device (i.e., no navigation system 243 and no graphic database 243), the navigation processing module 2454 may configure the processor 21 to set the current location of the portable electronic device 2 as the start location, and the event location as the destination location for subsequent transmission to such a LBS platform, which generates a navigation route and transmits the same back to the portable electronic device 2 for the user's reference.

The preference setup module 2455, when loaded into the processor 21, configures the processor 21 to enable the display device 25 to display an event type preference setting option, and to enable, upon detecting selection of the event type preference setting option, the display device 25 to display a plurality of event type preferences (e.g., arts, sports, local celebrations, exhibitions, promotion sales, food, etc.) made available for selection by the user via the input unit 26. The preference setup module 2455 further configures the processor 21 to store, upon detection of selection of at least one of the event type preferences, selected ones of the event type preferences in the storage unit 24. Preferably, the preference setup module 2455 further configures the processor 21 to transmit, via the communication unit 22, the selected ones of the event type preferences to the LBS platform 1 so as to allow the LBS platform 1 to update the user database 136 simultaneously. Accordingly, the processor 21 is configured by the brief notice processing module 2452 to retrieve the event title of the LBS event message from the storage unit 24, and to enable the display screen 25 to display the event title in the ticker display manner upon determining that an event type of the LBS event message has a match with the selected ones of the event type preferences stored in the storage unit 24.

The operation flow of the above described portable electronic device 2 and LBS platform 1 according to the preferred embodiment of the present invention will now be described in detail with reference to FIGS. 2 to 5.

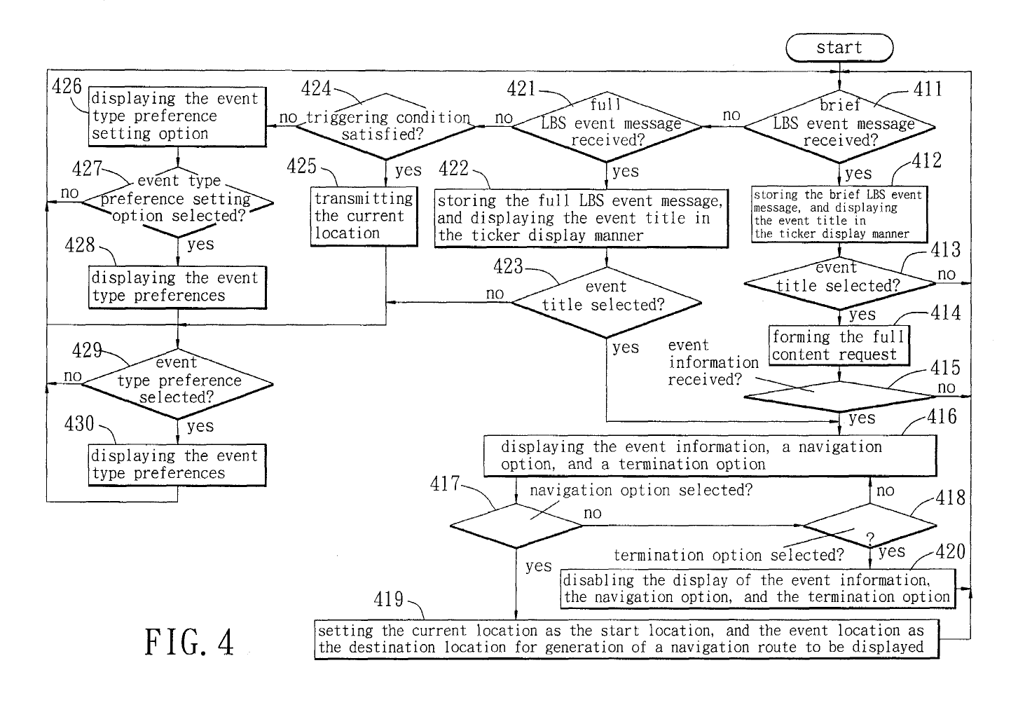

With reference to FIG. 1, FIG. 3 and FIG. 4, according to the method for displaying a LBS event message in a target portable electronic device 2 of the present invention, in step 411, the processor 21 of the target portable electronic device 2 determines whether a brief LBS event message, which includes an event identification code and an event title, has been received from the LBS platform 1 via the communication unit 22. If it is determined in step 411 that a brief LBS event message has been received, the flow continues to step 412, where the processor 21 stores the brief LBS event message in the storage unit 24, and is configured by the brief notice processing module 2452 to retrieve the event title of the brief LBS event message, and to enable the display screen 25 to display the event title in the ticker display manner such that the event title is available for selection by the user so as to notify the user of the target portable electronic device 2 of the presence of the corresponding upcoming event without interrupting current operation of the target portable electronic device 2. As mentioned above, the display may continue for a predefined period of time before it is terminated. Unlike the prior art, the user does not have to read through a full LBS event message in a conventional message reading manner that interrupts the current operation of the target portable electronic device 2, thereby increasing efficiency and decreasing any negative feelings that the user may have towards such LBS service. If it is determined in step 411 that no brief LBS event message has been received, the flow goes to step 421, which will be described later.

In step 413 following step 412, the processor 21 is configured by the content processing module 2453 to determine whether the event title has been selected via the input unit 26. If it is determined in step 413 that the event title has been selected, the flow goes to step 414. Otherwise, the flow goes back to step 411. In step 414, the processor 21 is configured by the content processing module 2453 to form the full content request, which contains the event identification code corresponding to the event title that has been selected and the user identification of the target portable electronic device 2 for requesting from the LBS platform 1 event information corresponding to the event title that has been selected.

In step 415, the processor 21 determines whether the event information as requested in step 414, which preferably includes the location, time, and introduction of the event corresponding to the event title that has been selected, has been received.

In step 416 following step 415, the processor 21 is configured by the content processing module 2453 and the navigation processing module 2454 to enable the display screen 25 to display the event information, as well as a navigation option and a termination option that are both available for selection by the user.

In step 417 following step 416, the processor 21 is configured by the navigation processing module 2454 to determine whether the navigation option has been selected via the input unit 26. If it is determined in step 417 that the navigation option has been selected, the flow goes to step 419, where the processor 21 is configured by the navigation processing module 2454 to set the current location of the target portable electronic device 2 as the start location, and the event location contained in the event information as the destination location for generation of a navigation route to be displayed on the display screen 25 as configured by the navigation system 243 so as to guide the user to the event location. After completing step 419, the flow goes back to step 411.

If it is determined in step 417 that the navigation option has not been selected, the flow goes to step 418, where the processor 21 is configured by the content processing module 2453 to determine whether the termination option has been selected. If it is determined in step 418 that the termination option has been selected, the flow goes to step 420, where the processor 21 disables the display of the event information, the navigation option, and the termination option on the display screen 25. Afterwards, the flow goes back to step 411. If it is determined in step 418 that the termination option has not been selected, the flow goes back to step 416 to continue displaying the event information, the navigation option and the termination option. It should be noted herein that the sequence of performing steps 417 and 418 may be interchanged, and that steps 417 and 418 maybe performed simultaneously in other embodiments of the present invention. Moreover, if the target portable electronic device 2 does not have navigation functionalities, the processor 21 may be configured by the navigation processing module 2454 to transmit the start location and the destination already set to a LBS platform that provides navigation services, and await for a navigation route to be provided by such LBS platform.

In step 421, the processor 21 determines whether a full LBS event message, which includes an event identification code, an event title and event information, has been received from other LBS platforms not in accordance with the present invention (e.g., LBS platforms 3, 4) via the communication unit 22. To determine the source of the LBS event message, identification information, e.g., IP address, of the LBS platforms may be utilized. If it is determined in step 421 that no full LBS event message has been received, the flow goes to step 424 (which will be described later). Otherwise, the flow goes to step 422, where the processor 21 stores the full LBS event message in the storage unit 24, and is configured by the brief notice processing module 2452 to retrieve the event title of the full LBS event message, and to enable the display screen 24 to display the event title in the ticker display manner such that the event title is available for selection by the user. Subsequently, in step 423, the processor 21 is configured by the content processing module 2453 to determine whether the event title has been selected via the input unit 26. If it is determined in step 423 that the event title has been selected, the flow goes to step 416, where the event information, the navigation option and the termination option are displayed on the display screen 25. Otherwise, the flow goes back to step 411.

In step 424, the processor 21 is configured by the location processing module 2451 to determine whether the triggering condition is satisfied, i.e., whether the current location of the target portable electronic device 2 has changed, or the predefined period of time has elapsed, or the target portable electronic device 2 has just been turned on. If it is determined in step 424 that the triggering condition is satisfied, the flow goes to step 425, where the processor 21 is configured by the location processing module 2451 to control the communication unit 22 to transmit the current location of the target portable electronic device 2 to the LBS platform 1 so as to inform the LBS platforms 1, 3, 4 of the same. Otherwise, the flow goes to step 426. Following the completion of step 425, the flow goes back to step 411.

In step 426, the processor 21 is configured by the preference set up module 2455 to enable the display device 25 to display the event type preference setting option. Subsequently, in step 427, the processor 21 is configured by the preference setup module 2455 to determine whether the event type preference setting option has been selected. If so, the flow goes to step 428, where the processor 21 is configured by the preference set up module 2455 to enable the display device 25 to display the event type preferences made available for selection by a user via the input unit 26. Otherwise, the flow goes back to step 411. Subsequently, in step 429, the processor 21 determines whether any of the event type preferences has been selected. If it is determined in step 429 that at least one of the event type preferences has been selected, the flow goes to step 430, where the processor 21 is configured by the preference setup module 2455 to store the selected ones of the event type preferences in the storage unit 24, and to transmit, via the communication unit 22, the selected ones of the event type preferences to the LBS platform 1 so as to allow the LBS platform 1 to update the user database 136 simultaneously. Otherwise, the flow goes back to step 411. After completion of step 430, the flow also goes back to step 411.

Optionally, an extra step (not shown) maybe performed before each of steps 412 and 422 is performed. In the extra step, the processor 21 determines whether the event type of the brief/full LBS event message has a match with the event type preferences stored in the storage unit 24 of the target portable electronic device 2. If the answer to the determination is yes, step 412/422 is performed. Otherwise, the flow goes back to step 411. It should be noted herein that the sequences of the determination steps 411, 421, 424, 427 may be adjusted according to design requirements, or may be conducted simultaneously in other embodiments of the present invention, and that implementation is not to be limited to that disclosed herein.

When the LBS event messages are displayed in the manner described above, the user of the target portable electronic device 2 is initially informed of the presence of nearby upcoming events displayed in the ticker display manner without interrupting the current operation of the target portable electronic device 2. If the user's interest is caught by any of the event titles displayed, the full event information corresponding thereto may be acquired and displayed at the user's request simply by selecting the event title with the input unit 26. This way, the user has the option of simply ignoring the event titles displayed in the ticker display manner if the same do not interest him/her, or choosing to interrupt the current operation of the target portable electronic device 2 by selecting the event title that he/she is interested in. Hence, there is no need for the LBS platform 1 to transmit a large volume of unwanted data to the target portable electronic device 2, and even if a large volume of data is received by the target portable electronic device 2 (e.g., from the LBS platforms 3, 4 not in accordance with the present invention), the target portable electronic device 2 can screen out preferred information for display to the user so that the user will not be thrown with all the information at once and get an unpleasant and annoying feeling.

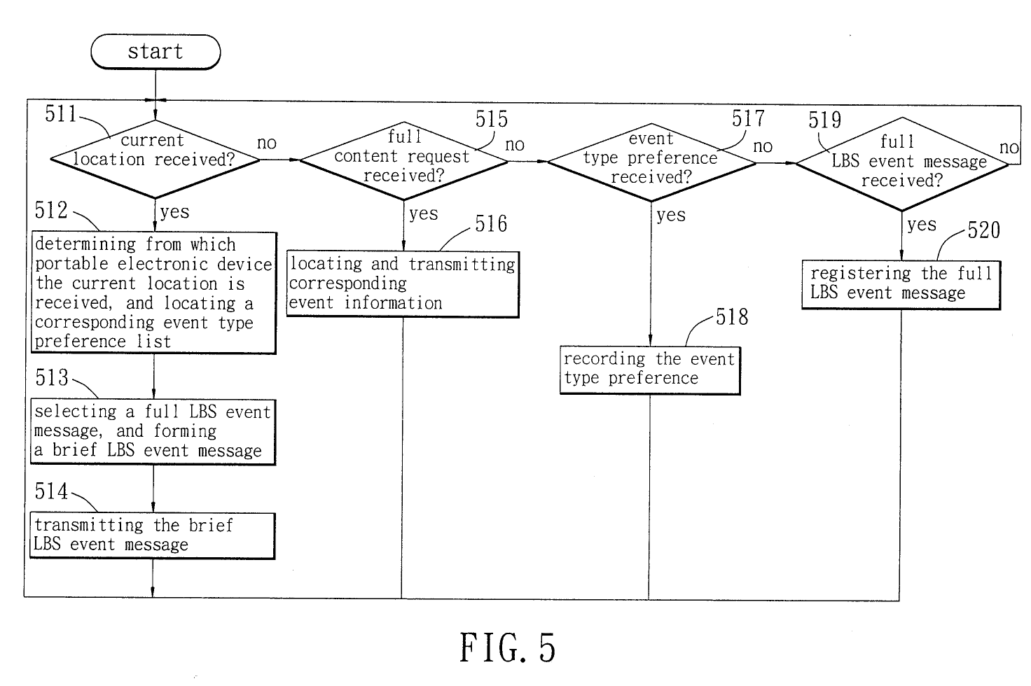

The method for providing LBS event information to a target portable electronic device 2 as implemented by the LBS platform 1 according to the preferred embodiment of the present invention will now be illustrated in detail hereinbelow with reference to FIG. 1, FIG. 2 and FIG. 5.

In step 511, the processor 11 of the LBS platform 1 determines whether a current location of a portable electronic device 2 is received. If it is determined in step 511 that a current location is received, the flow goes to step 512, where the processor 11 is configured by the brief message processing module 137 to determine from which portable electronic device 2 was the current location received by using the user identification, and to locate the event type preference list corresponding to the user identification in the user database 136. This portable electronic device 2 is hereinafter referred to as the target portable electronic device 2 for clarity of illustration.

Subsequently, in step 513, the processor 11 is configured by the brief message processing module 137 to select at least one full LBS event message from the LBS event database 134 that corresponds to the current location of the target portable electronic device 2 and that has a match with at least one event type in the event type preference list located in step 512 so as to form a brief LBS event message by extracting the event identification code and the event title from the full LBS event message thus selected.

Next, in step 514, the processor 11 is configured by the brief message processing module 137 to control the communication unit 12 to transmit the brief LBS event message to the target portable electronic device 2. After completion of step 514, the flow goes back to step 511.

If it is determined in step 511 that no current location is received, the flow goes to step 515, where the processor 11 is configured by the content processing module 138 to determine whether a full content request has been received. If it is determined in step 515 that a full content request has been received, the flow goes to step 516, where the processor 11 is configured by the content processing module 138 to locate the event information corresponding to the full content request using the event identification code, and transmits the same to the target portable electronic device 2 through the communication unit 12. Otherwise, the flow goes to step 517. After completion of step 516, the flow goes back to step 511.

In step 517, the processor 11 is configured by the user setting module 135 to determine whether an event type preference has been received from a portable electronic device 2. If it is determined in step 517 that an event type preference is received, the flow goes to step 518. Otherwise, the flow goes to step 519. In step 518, the processor 11 is configured to record, in the user database 136, the event type preference in the event type preference list corresponding to the particular portable electronic device 2 so as to update the user information. After completion of step 518, the flow goes back to step 511.

In step 519, the processor 11 is configured by the message registering module 133 to determine whether a full LBS event message is received, either through the input unit 14 or from other sources (e.g., other LBS platforms 3, 4). If it is determined in step 519 that a full LBS event message has been received, the flow goes to step 520. Otherwise, the flow goes back to step 511. In step 520, the processor 11 is configured by the message registering module 133 to register the full LBS event messages in the LBS event database 134. After completion of step 520, the flow goes back to step 511.

It should be noted herein that the sequence of the determination steps 511, 515, 517, 519 may be adjusted according to design requirements, or may be conducted simultaneously in other embodiments of the present invention, and that implementation is not to be limited to that disclosed herein.

In sum, the LBS platform 1 of the present invention provides the content of a full LBS event message in separate stages, where the event title of an event belonging to an event type preference of a target portable electronic device 2 is provided automatically to the target portable electronic device 2 upon being informed of a current location of the target portable electronic device 2, and the event information of the same event is provided to the target portable electronic device 2 only at the request of the target portable electronic device 2. On the other hand, the portable electronic device 2 of the present invention screens through the information received from the LBS platforms 1, 3, 4 to see if the event matches the user's preference(s), and if a match is found, displays the event title in a ticker display manner so as to notify the user of the presence of the event without interrupting the current operation of the portable electronic device 2. The portable electronic device 2 subsequently displays the event information only upon request by the user. As a result, not only is the volume of data transmission reduced significantly, but the LBS event notification service is also provided in a more customized manner. Moreover, the user of the portable electronic device 2 is allowed the option of choosing to ignore the event title of the LBS event message displayed in the ticker display manner and continue with the current operation of the portable electronic device 2, or to interrupt the current operation of the portable electronic device 2 and request for the event information at his/her own discretion.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for displaying a location based service (LBS) event message to be implemented by a target portable electronic device, the method comprising the steps of:
(a) upon receipt of the LBS event message, retrieving an event title from the LBS event message; and
(b) displaying the event title in a ticker display manner on a display screen of the target portable electronic device.

2. The method as claimed in claim 1, the LBS event message being a full LBS event message that contains the event title and event information, wherein, in step (b), the event title is displayed in a manner that the event title is made available for selection by a user of the target portable electronic device, the method further comprising the step of:
(c) upon detection of selection of the event title, displaying the event information on the display screen of the target portable electronic device.

3. The method as claimed in claim 1, the LBS event message being a brief LBS event message that contains the event title, wherein, in step (b), the event title is displayed in a manner that the event title is made available for selection by a user of the target portable electronic device, the method further comprising the steps of:
(c) upon detection of selection of the event title, transmitting a full content request to a location based service (LBS) platform for requesting event information corresponding to the event title that has been selected; and
(d) upon receipt of the event information, displaying the event information on the display screen of the target portable electronic device.

4. The method as claimed in claim 3, the target portable electronic device being a portable navigation device, the method further comprising the steps of:
(e) displaying a navigation option that is available for selection by the user on the display screen of the target portable electronic device; and
(f) upon detection of selection of the navigation option, setting a current location of the target portable electronic device as a start location, and an event location contained in the event information as a destination location for generation of a navigation route to be displayed on the display screen of the target portable electronic device.

5. The method as claimed in claim 3, wherein the event information includes at least one of location, time, and introduction of an event corresponding to the event title of the brief LBS event message.

6. The method as claimed in claim 1, the target portable electronic device having at least one event type preference stored therein, wherein step (a) is performed upon determining that an event type of the LBS event message has a match with said at least one event type preference stored in the target portable electronic device.

7. A method for providing location based service (LBS) event information to a target portable electronic device, the method being implemented by a location based service (LBS) platform and comprising the steps of:
(a) configuring the LBS platform to register therein a plurality of full LBS event messages, each of which contains an event identification code, an event title, and event information;
(b) configuring the LBS platform to form a brief LBS event message corresponding to one of the full LBS event messages by extracting the event identification code and the event title therefrom; and
(c) configuring the LBS platform to transmit the brief LBS event message to the target portable electronic device.

8. The method as claimed in claim 7, further comprising the step of:
(d) configuring the LBS platform to transmit, upon receipt of a full content request, the event information corresponding to the event title to the target portable electronic device.

9. The method as claimed in claim 8, wherein the LBS platform is configured to locate the event information corresponding to the full content request using the event identification code for subsequent transmission to the target portable electronic device.

10. The method as claimed in claim 7, further comprising the following step prior to step (a):
(e) configuring the LBS platform to select, upon being informed of a current location of the target portable electronic device, at least one brief LBS event message that corresponds to the current location of the target portable electronic device for transmission to the target portable electronic device in step (a).

11. The method as claimed in claim 10, further comprising the following step prior to step (e):
(f) upon receipt of at least one event type preference from the target portable electronic device, configuring the LBS platform to store said at least one event type preference;
wherein, in step (e), the LBS platform selects at least one brief LBS event message that corresponds to the current location of the target portable electronic device and that has a match with said at least one event type preference for transmission to the target portable electronic device in step (a).

12. A portable electronic device comprising:
a communication unit for receiving a location based service (LBS) event message from a location based service (LBS) platform;
a display screen;
a storage unit;
a processor coupled electrically to said communication unit, said display screen and said storage unit, and storing the LBS event message received via said communication unit in said storage unit; and
a brief notice processing module, which, when loaded into said processor, configures said processor to retrieve an event title of the LBS event message from said storage unit, and further configures said processor to enable said display screen to display the event title in a ticker display manner.

13. The portable electronic device as claimed in claim 12, the LBS event message being a full LBS event message that contains the event title and event information, wherein said brief notice processing module configures said processor such that the event title is displayed on said display screen in a manner that the event title is made available for selection by a user, said portable electronic device further comprising:
an input unit coupled electrically to said processor, and permitting the user to select the event title; and
a content processing module, which, when loaded into said processor, configures said processor to retrieve the event information of the LBS event message from said storage unit, and to enable said display screen to display the event information upon detection of selection of the event title.

14. The portable electronic device as claimed in claim 12, the LBS event message being a brief LBS event message that contains the event title, wherein said brief notice processing module configures said processor such that the event title is displayed on said display screen in a manner that the event title is made available for selection by a user, said portable electronic device further comprising:
an input unit coupled electrically to said processor and permitting the user to select the event title; and
a content processing module, which, when loaded into said processor, configures said processor to transmit, upon detection of selection of the event title through said communication unit, a full content request to the LBS platform for requesting event information corresponding to the event title that has been selected, and further configures said processor to enable, upon receipt of the event information from the LBS platform via said communication unit, said display screen to display the event information.

15. The portable electronic device as claimed in claim 14, further comprising:
a positioning unit for determining a current location of the portable electronic device;
a navigation system, which, when loaded into said processor, configures said processor to generate a navigation route based on a start location and a destination location; and
a navigation processing module, which, when loaded into said processor, configures said processor to enable said display screen to display a navigation option that is available for selection by the user when the event information is being displayed, and further configures said processor to set, upon detection of selection of the navigation option, the current location of the portable electronic device as the start location, and an event location contained in the event information as the destination location for subsequent generation of the navigation route by said navigation system.

16. The portable electronic device as claimed in claim 15, further comprising a location processing module, when loaded into said processor, configures said processor to control said communication unit to transmit the current location of the portable electronic device to the LBS platform so as to inform the LBS platform of the same upon determining that a triggering condition is satisfied.

17. The portable electronic device as claimed in claim 13, further comprising:
a preference setup module, which, when loaded into said processor, configures said processor to enable said display device to display a plurality of event type preferences made available for selection by a user; and
an input unit coupled electrically to said processor and permitting the user to select the event type preferences;
wherein said preference setup module, when loaded into said processor, further configures said processor to store, upon detection of selection of at least one of the event type preferences, selected ones of the event type preferences in said storage unit; and
wherein said brief notice processing module, when loaded into said processor, configures said processor to retrieve the event title of the LBS event message from said storage unit, and to enable said display screen to display the event title in a ticker disply manner upon determining that an event type of the LBS event message has a match with the selected ones of the event type preferences stored in said storage unit.

18. A location based service (LBS) platform comprising:
a communication unit;
a location based service (LBS) event database containing a plurality of full LBS event messages, each of which contains an event title and event information;
a processor coupled electrically to said communication unit and said LBS event database; and
a brief message processing module, which, when loaded into said processor, configures said processor to retrieve, upon determining that a triggering condition is satisfied, the event title of one of the full LBS event messages from said LBS event database so as to generate a brief LBS event message containing the event title, and to control said communication unit to transmit the brief LBS event message to a target portable electronic device.

19. The LBS platform as claimed in claim 18, further comprising a content processing module, which, when loaded into said processor, configures said processor to retrieve, upon receipt of a full content request from the target portable electronic device for requesting event information corresponding to the event title of the brief LBS event message, the event information from said one of the full LBS event messages, and to transmit the event information thus retrieved to the target portable electronic device.

20. The LBS platform as claimed in claim 18, wherein the triggering condition is satisfied when it is determined by said processor that a current location of the target portable electronic device is received via said communication unit.

21. The LBS platform as claimed in claim 20, further comprising a user database containing a plurality of event type preference lists respectively corresponding to a plurality of portable electronic device identifications;
each of the full LBS event messages further containing an event type, each of the event type preference lists having at least one event type;
a portable electronic device identification being received together with the current location of the target portable electronic device via said communication unit;
said processor being further configured by said brief message processing module to select, from said LBS event database, at least one of the full LBS event messages that has an event type corresponding to said at least one event type in the event type preference list that corresponds to the portable electronic device identification of the target portable electronic device;
the event title to be contained in the brief LBS event message for transmission to the target portable electronic device via said communication unit being retrieved by said processor from said at least one of the full LBS event messages thus selected.

22. The LBS platform as claimed in claim 17, further comprising a message registering module, which, when loaded into said processor, configures said processor to register the full LBS event messages into said LBS event database.
